(19) United States
(12) Patent Application Publication
(10) Pub. No.: US 2004/0130811 A1
(43) Pub. Date: Jul. 8, 2004

(54) Side view mirror

(76) Inventor: Terrance Campbell, Brooklyn, NY (US)

Correspondence Address: Matthew J. Peirce, Esq., 1550 Starlight Canyon Avenue, Las Vegas, NV, 89123, US

(21) Appl. No.: 10/052,922

(22) Filed: Jan. 23, 2002

(51) Int. Cl. G02B 7/182

(52) U.S. Cl. 359/872; 359/877

(57) ABSTRACT

A new and improved apparatus is disclosed for reducing the glare that is present in side view mirrors at night from headlights from other vehicles. The apparatus comprises a standard side view mirror that has an extra layer, with the extra layer being either a layer of tinted glass or smoked glass. The layer of tinted glass or smoked glass would be located on the outside of the standard rear view mirror.

### BACKGROUND OF THE INVENTION

The present invention is that of a new and improved apparatus for reducing the glare that is present in side view mirrors at night from headlights from other vehicles.

### DESCRIPTION OF THE PRIOR ART

U.S. Pat. No. 6,152,587, issued to Berg, discloses a side view mirror with auxiliary lights for providing additional signaling to other drivers so they are aware of vehicle operations.

U.S. Pat. No. 5,899,520, issued to Bryant, discloses a sun shield which is mounted on a bracket that is provided for support of a side-view mirror on a truck cab.

U.S. Pat. No. 5,877,837, issued to Hayes, discloses an ophthalmic shading device which depends from a structure worn on the head and provides a shading structure which may be mounted between a source of light to be attenuated and the human eye.

U.S. Pat. No. 5,844,733, issued to Ravanini, discloses a reversible external side view mirror which has a mirror element and a left/right reversing mechanism for alternatingly mounting the mirror on a left side and a right side of the vehicle.

U.S. Pat. No. 5,610,772, issued to lizuka, discloses a mirror housing of the automobile side view mirror which is of an ordinary shell type and so formed at the lower edge of the front opening thereof as to have a generally V-shaped section.

### SUMMARY OF THE INVENTION

The present invention is that of a new and improved apparatus for reducing the glare that is present in side view mirrors at night from headlights from other vehicles. The apparatus comprises a standard side view mirror that has an extra layer, with the extra layer being either a layer of tinted glass or smoked glass. The layer of tinted glass or smoked glass would be located on the outside of the standard rear view mirror.

There has thus been outlined, rather broadly, the more important features of a side view mirror in order that the detailed description thereof that follows may be better understood and in order that the present contribution to the art may be better appreciated. There are, of course, additional features of the side view mirror that will be described hereinafter and which will form the subject matter of the claims appended hereto.

In this respect, before explaining at least one embodiment of the side view mirror in detail, it is to be understood that the side view mirror is not limited in its application to the details of construction and to the arrangements of the components set forth in the following description or illustrated in the drawings. The side view mirror is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present side view mirror. It is important, therefore, that the claims be regard as including such equivalent constructions insofar as they do not depart from the spirit and scope of the present invention.

It is therefore an object of the present invention to provide a side view mirror which has all of the advantages of the prior art and none of the disadvantages.

It is another object of the present invention to provide a side view mirror which may be easily and efficiently manufactured and marketed.

It is another object of the present invention to provide a side view mirror which is of durable and reliable construction.

It is yet another object of the present invention to provide a side view mirror which is economically affordable and available to the buying public.

It is yet another object of the present invention to provide a side view mirror which provides additional benefits not present in the prior art.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a side view of the present invention.

FIG. 2 shows a front view of the present invention.

FIG. 3 shows a perspective view of the present invention in use.

### DESCRIPTION OF THE PREFERRED EMBODIMENT

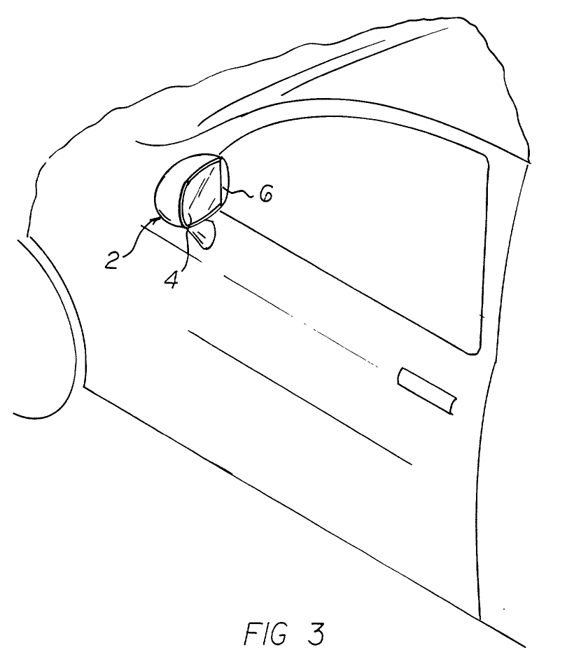

FIG. 1 shows a side view of the present invention. The present invention is that of a new and improved apparatus for reducing the glare that is present in side view mirrors at night from headlights from other vehicles. The apparatus comprises a standard side view mirror 2 that has an extra glass layer 4, with the extra glass layer 4 being either a layer of tinted glass or smoked glass. The extra glass layer 4 would be located on the outside of the standard rear view mirror 2 and would serve to reduce glare from headlights from vehicles that would be located behind the particular vehicle that the present invention would be attached to.

The present invention would be located within casing 6, which would protect both side view mirror 2 and extra glass layer 4, along with a control 8 which would be located on the inside of a driver's door. Control 8 would be connected to side view mirror 2 via connective means 10, which would preferably be one or more wires or cables. Control 8 could be either a mechanical or electronic control.

FIG. 2 shows a front view of the present invention, while FIG. 3 shows a perspective view of the present invention in use on a vehicle.

What I claim as my invention is:

1. A side view mirror in combination with a vehicle comprising:
(a) a mirror, the mirror including a front surface, (b) a glass layer attached to the front surface of the mirror, (c) a casing to house the mirror, the casing attached to the vehicle, and (d) at least one control inside the vehicle for moving the mirror.

2. A side view mirror in combination with a vehicle according to claim 1 wherein the glass layer attached to the front surface of the mirror would be tinted glass.

3. A side view mirror in combination with a vehicle according to claim 1 wherein the glass layer attached to the front surface of the mirror would be smoked glass.

4. A side view mirror in combination with a vehicle according to claim 1 wherein the control inside the vehicle for moving the mirror would be a mechanical control.

5. A side view mirror in combination with a vehicle according to claim 1 wherein the control inside the vehicle for moving the mirror would be an electrical control.
